(19) United States
(12) Patent Application Publication
(10) Pub. No.: US 2010/0034966 A1
(43) Pub. Date: Feb. 11, 2010

(54) SYSTEM, METHOD AND APPARATUS FOR PLANARIZING MEDIA TOPOGRAPHY VIA SOAKING IN DILUTE NON-FUNCTIONALIZED POLYMER SOLUTION

(75) Inventors: QING DAI, San Jose, CA (US); XING-CAI GUO, Tracy, CA (US); DAN SAYLOR KERCHER, Santa Cruz, CA (US); BRUNO MARCHON, Palo Alto, CA (US); MIKE SUK, Palo Alto, CA (US)

Correspondence Address: Larson Newman & Abel, LLP, 5914 West Courtyard Drive, Suite 200, Austin, TX, 78730, US

(73) Assignee: Hitachi Global Storage Technologies Netherlands BV, Amsterdam (NL)

(21) Appl. No.: 12/186,596

(22) Filed: Aug. 6, 2008

(51) Int. Cl. B05D 5/12

(52) U.S. Cl. 427/130

(57) ABSTRACT

A method for planarizing media disk surfaces with a polymer solution is disclosed. A non-functionalized lubricant is used to coat the disk surfaces without dewetting issues. The polymer is applied via soaking in a diluted solution for several minutes. The interaction of the polymer with the disk surface leads to preferential adsorption of lubricant into the valleys of the topography on the disk surface.

### BACKGROUND OF THE INVENTION

1. Technical Field

The present invention relates in general to magnetic media topography and, in particular, to a n improved system, method and apparatus for planarizing magnetic media topography via soaking in a diluter non-functionalized polymer solution.

2. Description of the Related Art

Data access and storage systems generally comprise one or more storage devices that store data on magnetic or optical storage media. For example, a magnetic storage device is known as a direct access storage device or a hard disk drive (HDD) and includes one or more disks and a disk controller to manage local operations concerning the disks. The hard disks themselves are usually made of aluminum alloy, glass or a mixture of glass and ceramic, and are covered with a magnetic coating that contains the bit pattern. Typically, one to five disks are stacked vertically on a common spindle that is turned by a disk drive motor at several thousand revolutions per minute. Hard disk drives have several different typical standard sizes or formats, including server, desktop, mobile and microdrive.

A typical HDD also uses an actuator assembly to move magnetic read/write heads to the desired location on the rotating disk so as to write information to or read data from that location. Within most HDDs, the magnetic read/write head is mounted on a slider. A slider generally serves to mechanically support the head and any electrical connections between the head and the rest of the disk drive system. The slider is aerodynamically shaped to glide over moving air in order to maintain a uniform distance from the surface of the rotating disk, thereby preventing the head from undesirably contacting the disk.

A slider is formed with an aerodynamic pattern of protrusions on its air bearing surface that enables the slider to fly at a constant height close to the disk during operation of the disk drive. A slider is associated with each side of each disk and flies just over the disk's surface. Each slider is mounted on a suspension to form a head gimbal assembly (HGA). The HGA is then attached to a semi-rigid actuator arm that supports the entire head flying unit. Several semi-rigid arms may be combined to form a single movable unit having either a linear bearing or a rotary pivotal bearing system.

The head and arm assembly is linearly or pivotally moved utilizing a magnet/coil structure that is often called a voice coil motor (VCM). The stator of a VCM is mounted to a base plate or casting on which the spindle is also mounted. The base casting with its spindle, actuator VCM, and internal filtration system is then enclosed with a cover and seal assembly to ensure that no contaminants can enter and adversely affect the reliability of the slider flying over the disk. When current is fed to the motor, the VCM develops force or torque that is substantially proportional to the applied current. The arm acceleration is therefore substantially proportional to the magnitude of the current. As the read/write head approaches a desired track, a reverse polarity signal is applied to the actuator, causing the signal to act as a brake, and ideally causing the read/write head to stop and settle directly over the desired track.

Two types of magnetic media are bit patterned media and discrete track media. Both bit patterned media and discrete track media employ a patterning of surface topography on the disks of hard disk drives. Large variation in surface topography leads to high flying height modulation of the slider relative to the disk. There is a critical need to level or planarize the media topography to overcome this problem.

One solution that addresses this problem is disclosed in U.S. Pat. No. 6,680,079. A cross-linked perfluoropolyether (PFPE) acrylate is used to fill the gaps in the media via a brief dip coating, followed by IV cure of the acrylate. Such technology is limited in usefulness since mere dip coating (i.e., for a few seconds) alone is insufficient to provide full planarization without causing accumulation of the polymer on the disk surface. For example, FIG. 4 illustrates that a significant amount of accumulation 41 occurs on the peaks, and that the valleys 43 are not sufficiently planaraized at almost 5 nm of depth. Such recession (see, e.g., FIG. 3) is further increased to 10 or more after UV curing, as disclosed in the patent.

One method to reduce such recession is to perform a second dip coating. However, due to the polar end groups of the PFPE acrylate, the second dip forms a dewetted second layer, leading to unwanted accumulation at the topography edges. Thus, the use of PFPE acrylate promotes dewetting at the topography edges, which facilitates additional topography and more of the same types of problems. These issues are caused by the polar functionalized end groups on the polymer that chemically react with the materials they contact. Thus, although these solutions are workable for some applications, an improved method for overcoming the limitations of the prior art would be desirable.

### SUMMARY OF THE INVENTION

A system, method, and apparatus for planarizing media disk surfaces with full planarization and minimal excess accumulation of polymer solution are disclosed. A high molecular weight lubricant with non-functionalized end groups is used to coat the disk surfaces at various thicknesses. However, the lubricant does not have the dewetting problems associated with prior art materials.

The polymer is applied via soaking in diluted polymer solution for several minutes. The interaction of the polymer with the disk surface leads to preferential adsorption of lubricant into the valleys of the topography on the disk surface. Without exposure via the soaking process for several minutes, the planarization can take days, if at all, since slower ambient diffusion would be required to drive the planarization process. The soaking method allows sufficient polymer mobility to migrate into gaps to achieve planarization in a fraction of the time that would otherwise be required.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1 is a schematic side view of disk topography that has been processed with one embodiment of a method in accordance with the invention;

FIG. 2 is a plot of the processed disk topography of FIG. 1 and is constructed in accordance with the invention;

FIG. 3 is a plot of a conventional, unprocessed disk topography;

FIG. 4 is a plot of a conventionally processed disk topography;

FIG. 5 is a high level flow diagram of one embodiment of a method in accordance with the invention; and

FIG. 6 is a schematic sectional side view of an alternate embodiment of the invention.

### DETAILED DESCRIPTION OF THE INVENTION

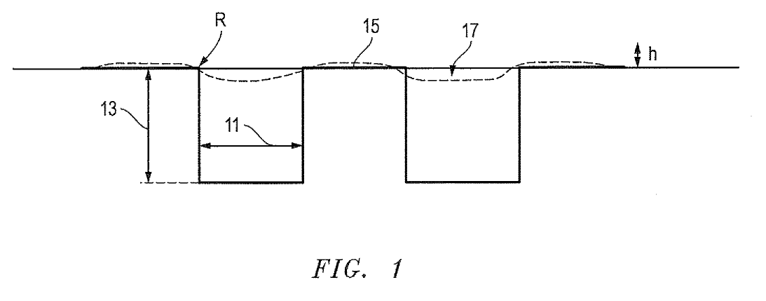

Referring to FIGS. 1, 2, 5 and 6, embodiments of a system, method and apparatus for planarizing media disk surfaces with full planarization and minimal excess accumulation of polymer solution are disclosed. A lubricant with non-functionalized end groups is used to coat the disk surfaces at various thicknesses. The lubricant does not have the dewetting problems associated with prior art materials since it does not chemically react.

At equilibrium conditions, the polymer exerts capillary pressure in the topography gaps as the driving force that leads to planarization of the lubricant film on the disk. This force is balanced by disjoining pressure, which is the force it takes to disjoin a molecule from the film. Thus, disjoining pressure attempts to maintain the film layer intact, and capillary pressure attempts to pull molecules away from the film and accumulate in gaps.

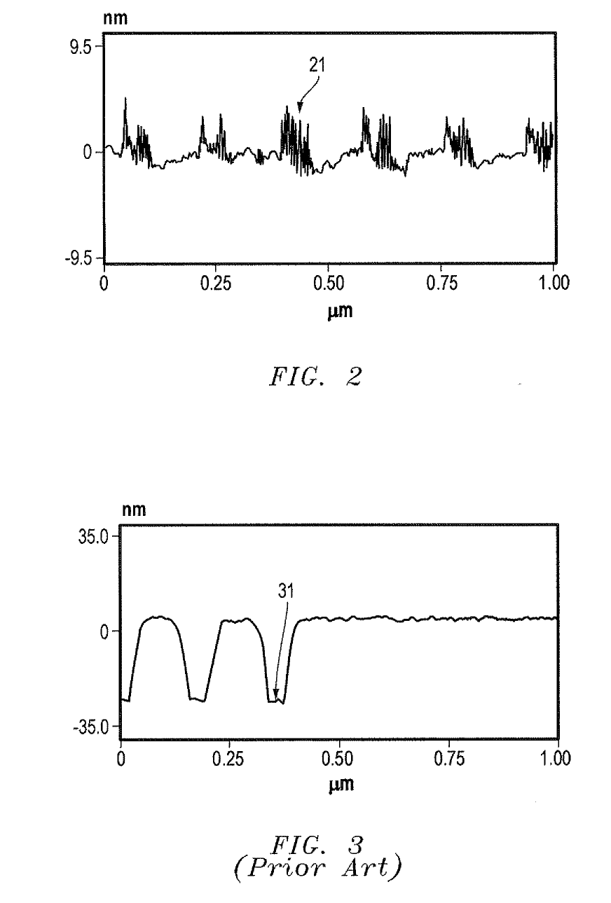

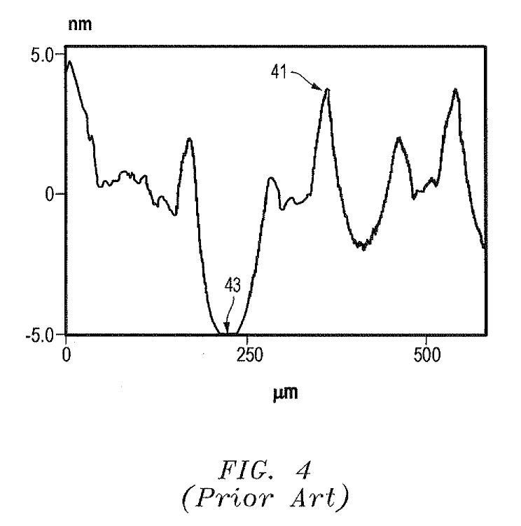

For example, FIG. 1 depicts a disk topography feature or gap 11 having a width (i.e., “horizontal” distance) of about 50 nm and a depth 13 (i.e., “vertical” valley) of about 40 nm. Peaks or pillars 15 are located between gaps 11 and may be planarized with the invention to less than 3 nm of recession 17. Moreover, accumulation on top of the pillars 15 in the disk topography is limited to within about 1 to 1.5 nm, which is acceptably within the range of thickness of the lubricant itself. FIG. 2 illustrates a plot of the processed disk topography of FIG. 1 in accordance with the invention, showing an average recession 21 of about 1.9 nm. In contrast, FIG. 3 depicts a conventional, unprocessed disk topography having about 30 nm of recession 31.

The polymer solution is applied via soaking in diluted polymer solution for a period of more than a few seconds. For example, a 1% by weight concentration of the lubricant may be used, depending on the thickness allowed on the tops of the pillars of the topography. Processing in accordance with the invention may be completed in only minutes. The interaction of the polymer with the disk surface leads to preferential adsorption of lubricant into the valleys of the topography on the disk surface. Without exposure via the soaking process for several minutes, the planarization can take days, if at all, since slower ambient diffusion would be required to drive the planarization process. The soaking method allows sufficient polymer mobility to migrate into the gaps to achieve planarization in a fraction of the time that would otherwise be required.

In one embodiment, the process comprises diluting a high molecular weight PFPE Z lubricant—without functional groups—in a solvent (e.g., hydrofluoroether (HFE)) to form a solution. The patterned media disks have a protective overcoat layer and are soaked, or immersed for a dwell time (e.g., at least 5 minutes), in the solution. The disks are then removed from the solution to achieve the desired planarization with a layer or coating of the lubricant remaining on the disk surface. Optionally, thermal or UV curing exposure may be used to strengthen the polymer in the gaps of the topography and reduce topography roughness. Although UV exposure will not cause ideal cross-linking (because of the lack of functional groups) it will help strengthen the polymer by attacking the backbone of the structure to some extent.

In one embodiment, the non-functional lubricant comprises the following formula:

CF₃O—(CF₂—CF₂—O)ₐ—(CF₂—O)_{b}—CF₃O

The variables “a” and “b” are selected to provide the lubricant with an average molecular weight in a range of about 70,000 to 100,000. Significantly, the CF₃O group on each end of the lubricant composition are inert and do not chemically react with other substances such as the overcoat layer on the disk surface. Thus, the composition does not have the dewetting problems associated with prior art acrylates.

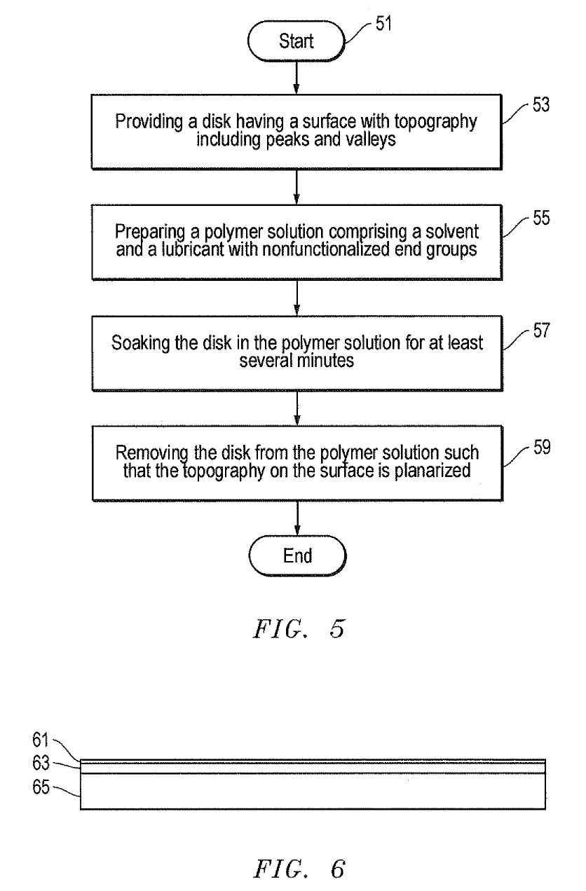

Since the polymer has no functional group, it does not cause dewetting and is able to provide full planarization. However, for some applications, this lower level of chemical strength may cause at least some of the polymer to spin off the disk but can be compensated for in disk drive applications requiring high rotational speeds. For applications requiring higher capillary pressure strength (e.g., FIG. 6; not to scale), the invention may be modified to include a very thin top coat 61 (e.g., a carbon film, a cross-linkable polymer, etc.) to enhance retention of the non-functionalized polymer or lubricant coating or layer 63 on the disk 65.

Referring to FIG. 5, one embodiment of a method of planarizing a media disk begins as indicated at step 51, and comprises providing a disk having a surface with topography including pillars (i.e., peaks) and valleys (step 53); preparing a polymer solution comprising a solvent and a lubricant with non-functionalized end groups (step 55); soaking the disk in the polymer solution for at least several minutes (step 57); removing the disk from the polymer solution such that the topography on the surface is planarized (step 59); before ending as indicated at step 61.

In other embodiments, the method comprises accumulating the lubricant on the land or tops of the pillars within about 1 nm in thickness, and a recession of lubricant from the valleys at less than 3 nm in thickness. As described herein, the lubricant may comprises a high molecular weight PFPE Z lubricant, and the solvent may comprise hydrofluoroether (HFE). The soaking step may comprise at least 5 minutes in dwell time. The method may further comprise thermal or UV curing of the polymer solution to strengthen the polymer solution in the topography and reduce topography roughness. The lubricant may comprise the chemical formula: CF₃O—(CF₂—CF₂—O)ₐ—(CF₂)_{b}—CF₃O, wherein a and b are selected to provide the lubricant with an average molecular weight in a range of about 70,000 to 100,000.

While the invention has been shown or described in only some of its forms, it should be apparent to those skilled in the art that it is not so limited, but is susceptible to various changes without departing from the scope of the invention.

What is claimed is:

1. A method of planarizing a media disk, comprising:
(a) providing a disk having a surface with topography including peaks and valleys;
(b) preparing a polymer solution comprising a solvent and a lubricant with non-functionalized end groups;
(c) soaking the disk in the polymer solution for at least several minutes; and
(d) removing the disk from the polymer solution such that the topography on the surface is planarized by a layer of the lubricant on the surface.

2. A method according to claim 1, further comprising accumulating the lubricant on the peaks within about 1 nm in thickness, and a recession of lubricant from the valleys at less than 3 nm in thickness.

3. A method according to claim 1, wherein the lubricant is diluted with the solvent at about 1% weight concentration.

4. A method according to claim 1, wherein the lubricant comprises a high molecular weight PFPE Z lubricant.

5. A method according to claim 1, wherein the solvent comprises hydrofluoroether (HFE).

6. A method according to claim 1, wherein step (c) comprises at least 5 minutes in dwell time.

7. A method according to claim 1, further comprising thermal or UV curing of the polymer solution to strengthen the polymer solution in the topography and reduce topography roughness.

8. A method according to claim 1, wherein the lubricant comprises a chemical formula:
CF₃O—(CF₂—CF₂—O)ₐ—(CF₂—O)_{b}—CF₃O.

9. A method according to claim 8, wherein a and b are selected to provide the lubricant with an average molecular weight in a range of about 70,000 to 100,000.

10. A method according to claim 1, further comprising, after step (d), applying a top coat to the lubricant layer to enhance retention of the lubricant layer on the disk.

11. A method according to claim 10, wherein the top coat is selected from the group consisting of a carbon film and a cross-linkable polymer.

12. A method of planarizing a magnetic media disk, comprising:
(a) providing a disk having a surface with topography including peaks and valleys;
(b) preparing a polymer solution comprising a solvent and a lubricant with non-functionalized end groups, the lubricant comprising a high molecular weight PFPE Z lubricant;
(c) soaking the disk in the polymer solution for at least 5 minutes; and
(d) removing the disk from the polymer solution such that the topography on the surface is planarized by a layer of the lubricant on the surface.

13. A method according to claim 12, further comprising accumulating the lubricant on the peaks within about 1 nm in thickness, and a recession of lubricant from the valleys at less than 3 nm in thickness.

14. A method according to claim 12, wherein the lubricant is diluted with the solvent at about 1% weight concentration.

15. A method according to claim 12, wherein the solvent comprises hydrofluoroether (HFE).

16. A method according to claim 12, further comprising thermal or UV curing of the polymer solution to strengthen the polymer solution in the topography and reduce topography roughness.

17. A method according to claim 12, wherein the lubricant comprises a chemical formula:
CF₃O—(CF₂—CF₂—O)ₐ—(CF₂—O)_{b}—CF₃O
wherein a and b are selected to provide the lubricant with an average molecular weight in a range of about 70,000 to 100,000.

18. A method according to claim 12, further comprising, after step (d), applying a top coat to the lubricant layer to enhance retention of the lubricant layer on the disk.

19. A method according to claim 18, wherein the top coat is selected from the group consisting of a carbon film and a cross-linkable polymer.
